(19) United States
(12) Patent Application Publication
(10) Pub. No.: US 2005/0243356 A1
(43) Pub. Date: Nov. 3, 2005

(54) Image processing apparatus, image processing method and storage medium storing program for image processing

(75) Inventors: Yoshiharu Hibi, Ebina-shi (JP); Ryouichi Satoh, Ebina-shi (JP); Nobuhisa Katoh, Ebina-shi (JP); Mari Kodama, Ebina-shi (JP); Katsuyuki Asai, Ebina-shi (JP); Yasuaki Mitobe, Ebina-shi (JP); Seiji Iino, Ebina-shi (JP)

Correspondence Address: OLIFF & BERRIDGE, P.O. BOX 19928, ALEXANDRIA, VA, 22320, US

(73) Assignee: FUJI XEROX CO., LTD., Tokyo (JP)

(21) Appl. No.: 10/992,944

(22) Filed: Nov. 22, 2004

(30) Foreign Application Priority Data
Apr. 30, 2004 (JP) 2004-136745

(51) Int. Cl. G06F 15/00

(52) U.S. Cl. 358/1.13

(57) ABSTRACT

An image processing apparatus includes: an accepting unit that accepts an image forming instruction; a forming image generating unit that generates plural forming processing images corresponding to respective plural image forming devices on the basis of the accepted image forming instruction; and an output unit that outputs the plural forming processing images to the corresponding image forming devices.

### BACKGROUND OF THE INVENTION

1. Field of the Invention

The present invention relates to an image processing apparatus, an image processing method, and a storage medium storing a program for image processing, for generating a forming processing image to be processed in an image forming device such as a printer.

2. Description of the Related Art

Recently, printers having various functions have been developed. Such printers having various functions are often utilized for specific applications. It is known to provide a technique to realize printing at a higher speed by processing a single print job utilizing plural output machines.

However, in the above-described conventional technique, though efficient use of the plural printers is considered, for example, when a single document must be printed in different printing modes (for example, when a user wants to see a comprehensive layout and an imposed manuscript at a time), printers suitable for applications must be selected and printing by each printer must be instructed separately. There has been no technique that is developed in view of improving convenience in such cases.

When a user wants to print in plural forming modes (for example, when a user wants to print a document containing plural pages and to print an image containing a list of thumbnails for the individual pages), the user must prepare each image data and instruct printing of each image data separately. This is not very convenient.

### SUMMARY OF THE INVENTION

The present invention has been made in view of the above-described circumstances and provides an image processing apparatus, an image processing method, and a storage medium storing a program for image processing that enable improvement in convenience.

According to an aspect of the invention, an image processing apparatus includes: an accepting unit that accepts an image forming instruction; a forming image generating unit that generates plural forming processing images corresponding to respective plural image forming devices on the basis of the accepted image forming instruction; and an output unit that outputs the plural forming processing images to the corresponding image forming devices.

### BRIEF DESCRIPTION OF THE DRAWINGS

Embodiments of the present invention will be described in detail based on the following figures, wherein:

FIG. 1 is a structural block diagram showing a structure of an image processing apparatus and an example of its connection according to a first embodiment of the present invention;

FIG. 2 is an explanatory view showing an example of user interface screen in a user-side device 2;

FIG. 3 is an explanatory view showing another example of user interface screen in the user-side device 2;

FIG. 4 is a flowchart showing an example of processing in the image processing apparatus according to the embodiment of the present invention;

FIG. 5 is a structural block diagram showing another example of connection of the image processing apparatus according to the first embodiment of the present invention; and

FIG. 6 is a structural block diagram showing an example of connection of an image processing apparatus according to a second embodiment of the present invention.

### DETAILED DESCRIPTION OF THE INVENTION

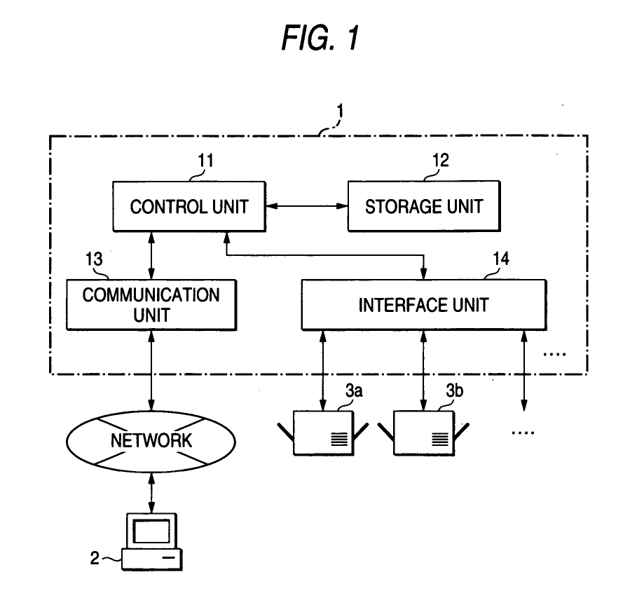

A first embodiment of the present invention will now be described with reference to the drawings. An image processing apparatus 1 according to this embodiment is connected with a user-side device 2 and plural printer devices 3a, 3b, . . . , as shown in FIG. 1. This image processing apparatus 1 includes a control unit 11, a storage unit 12, a communication unit 13, and an interface unit 14.

The control unit 11 can be realized by a CPU (central processing unit) or the like and operates in accordance with programs stored in the storage unit 12. As this control unit 11 accepts an image forming instruction, it performs processing to generate forming processing images according to plural forming modes that are different from each other, in accordance with the image forming instruction. The forming processing images are, for example, bitmap image data, and the processing to generate the forming processing images is equivalent to so-called raster image processing (RIP). The contents of the specific processing in this control unit 11 will be later described in detail.

The storage unit 12 contains a computer-readable storage medium storing programs to be executed by the control unit 11. Specifically, this storage unit 12 can be realized by a semiconductor device such as EEPROM (electrically erasable and programmable read-only memory) or RAM (random access memory).

The communication unit 13 is connected to the user-side device 2 via a network. This communication unit 13 receives data according to an image forming instruction from the user-side device 2 (for example, print instruction data described in PostScript (trademark registered) and data of its print parameters or the like) and outputs the data to the control unit 11.

The interface unit 14 is connected to the plural printer devices 3 and sends and outputs data of a corresponding forming processing image to each printer device 3 in accordance with an instruction inputted from the control unit 11. Specifically, this interface unit 14 may be an interface such as USB (universal serial bus) or a network interface.

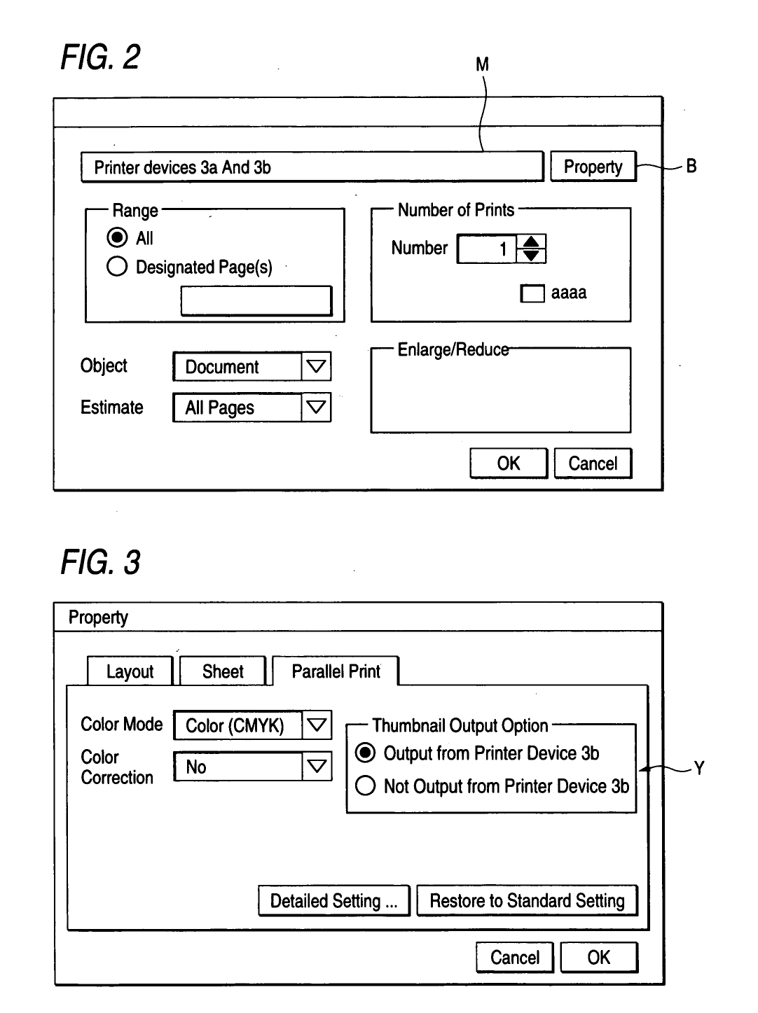

The user-side device 2 can be realized by a general personal computer. One of the characteristic features of this embodiment is that an interface that enables the user to make a print instruction to the plural printer devices 3 is presented in the processing at a printer driver of this user-side device 2, as shown in FIG. 2.

That is, in the user-side device 2 in this embodiment, the user can designate a print instruction to the plural printer devices 3 by using a selection menu M. In the example shown in FIG. 2, printing is to be carried out by the printer devices 3a and 3b. If a button B for detailed setting is clicked here, an interface element for designating a mode for at least one of the designated plural printer devices 3 that is different from the mode of the other printer device 3 may be displayed as optional setting at the time of printing (setting of print parameters) (see FIG. 3). In FIG. 3, an interface element (Y) for setting whether a thumbnail is to be outputted by the printer 3b or not is displayed.

The user-side device 2 sends information specifying the designated printer device 3 (information specifying each of the plural printer devices 3 when the plural printer devices are designated) and the inputted optional setting as data of print parameters together with the image data as a forming processing target (data of image forming instruction) to the image processing apparatus 1.

In the processing at the printer driver of this user-side device 2, an instruction to cause one printer device 3 to perform printing in plural printing modes can be made. In this case, a menu item to the effect that a print instruction to set plural printing modes in the one printer device 3 should be made is selected, for example, in the selection menu M.

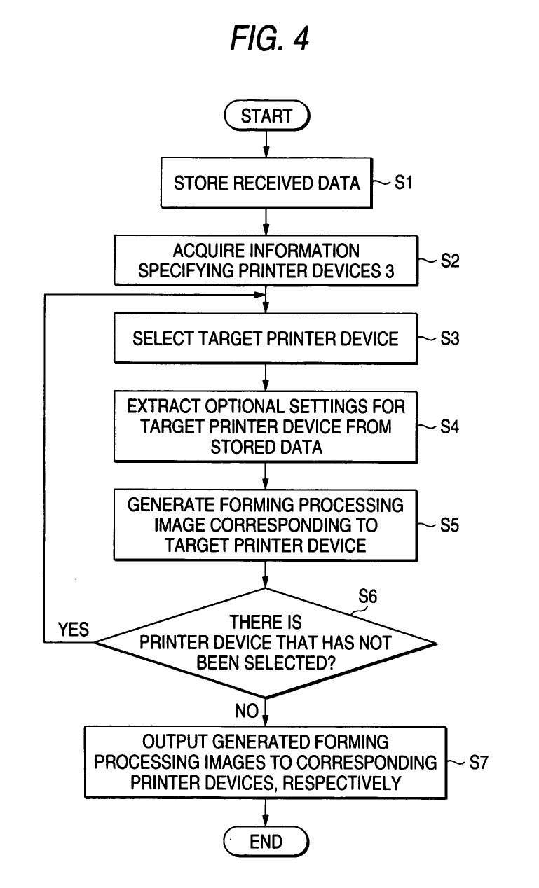

Next, the contents of the processing by the control unit 11 of the image processing apparatus 1 will be described. Upon receiving input of an image forming instruction received by the communication unit 13 from the user-side device 2, the control unit 11 starts processing shown in FIG. 4 and stores the data of the image forming instruction to the storage unit 12 (S1). Here, the image forming instruction contains print instruction data described in, for example, PostScript (trademark registered), and data of its print parameters and the like.

The control unit 11 acquires information specifying the printer devices 3 from the data stored in this storage unit 12, with reference to the print parameter part (S2). Then, the control unit 11 selects one printer device that has not been selected yet from the information specifying the printer devices 3, as a target printer device 3 (S3), and extracts optional settings related to the target printer device 3 from the optional settings of the data stored in the storage unit 12 (S4). That is, of the information of the optional settings received from the user-side device 2, the optional settings for one or some of the printer devices 3 are associated with the information specifying the one or some of the printer devices 3. The optional settings common to all the printer devices 3 are not associated with the information specifying the one or some of the printer devices 3. Therefore, for example, when extracting optional settings related to the printer device 3b, the control unit 11 selectively extracts optional settings associated with information specifying the printer device 3b and optional settings that are not associated with the information specifying any printer device 3.

The control unit 11 generates a forming processing image for the target printer device 3 on the basis of the option information extracted by the processing S4 and the image forming instruction stored in the storage unit 12 (S5). Here, the forming processing image is bitmap data (raster data) used for forming an image, and this processing S5 is similar to the processing that is generally called RIP.

The control unit 11 associates the generated forming processing image with the information specifying the target printer device 3 and stores them to the storage unit 12.

The control unit 11 also checks whether there is any printer device that has not been selected as a target printer device 3, of the printer devices 3 specified by the information acquired by the processing S2 (S6). If there is such a printer device 3 (if the result is YES), the control unit 11 returns to the processing S3, selects the printer device 3 that has not been selected as a target printer device 3, and performs processing. If there is no printer device 3 that has not been selected (if the result is NO) in the processing S6, the control unit 11 outputs each of the data of the forming processing images stored in the storage unit 12 to the printer devices 3 specified by the respective associated information items (that is, the control unit 11 outputs the data of each forming processing image to the corresponding printer device 3) (S7), and ends the processing.

The printer device 3 that has received the forming processing image from the image processing apparatus 1 in this embodiment forms an image on a recording medium such as a sheet in accordance with the contents of the forming processing image. This processing is similar to the operation by an ordinary printer device for printing based on an image after RIP and therefore will not be described further in detail.

In this manner, according to this embodiment, as the user-side device 2 designates the plural printer devices 3 and makes a print instruction thereto, the document as an object of the print instruction is printed by the designated plural printer devices 3. That is, the image processing apparatus 1, having received the print instruction from the user-side device 2, generates plural forming processing images corresponding to the respective designated plural printer devices 3 on the basis of the data of the image forming instruction contained in the received print instruction. Then, each of the plural forming processing images is outputted to the corresponding printer device 3 and the document as an object of the print instruction is printed by the designated plural printer devices 3.

As for these plural printer devices, though plural printers of the same type may be connected, the effect of the present invention is more remarkable in the case where printer devices of different modes are combined, for example, in the case where a large-size printer capable of outputting A1 size and a color printer capable of outputting A3 size at a high speed or the like are combined and connected, or in the case where a high-speed color printer and a color printer of low speed but high image quality are combined and connected.

Thus, when one document must be printed in different printing modes (for example, when a user wants to see a comprehensive layout and an imposed manuscript at a time), it is not necessary to separately make a print instruction to each printer device and the convenience can be improved.

Moreover, since data transfer processing of print data from the user-side device to the print server, which generally requires transfer of a large volume of data, need be carried out only once, there is an advantage that the cost of network transfer can be significantly reduced.

Also, as the user-side device 2 designates plural forming modes (for example, it designates ordinary print and print with a thumbnail arranged on each page) and makes a print instruction, a document as an object of the print instruction is printed in the designated plural forming modes. That is, the image processing apparatus 1, having received the print instruction from the user-side device 2, generates forming processing images in the designated plural forming modes corresponding to the designated printer devices 3 on the basis of the data of image forming instruction contained in the accepted print instruction. Then, the plural forming processing images are outputted to the respective designated printer devices 3 and the document as an object of the print instruction is printed in the designated various forming modes by the designated printer devices 3.

In the above description, the image processing apparatus 1 of this embodiment generates forming processing images corresponding to the respective designated plural printer devices 3. However, the following structure may be employed instead.

That is, a corresponding printer server S may be provided for each printer device 3, as shown in FIG. 5, and each printer server S may perform RIP processing for the corresponding printer device 3 (processing to generate a forming processing image corresponding to the printer device 3).

In this case, the control unit 11 of the image processing apparatus 1 outputs the option information extracted by the processing S4 and the image forming instruction stored in the storage unit 12 to the printer server S corresponding to the target printer device 3, and the control unit 11 causes the printer server S to generate a forming processing image and output the generated forming processing image to the target printer device 3, instead of the processing S5 shown in FIG. 4.

In short, in this case, the forming image generating unit according to the present invention that generates plural forming processing images corresponding to plural image forming devices is realized by the processing in the control unit 11 to cause the printer server S to perform RIP processing, and the output unit is realized by the processing in the control unit 11 to cause the printer server S to output the forming processing image to each printer device 3.

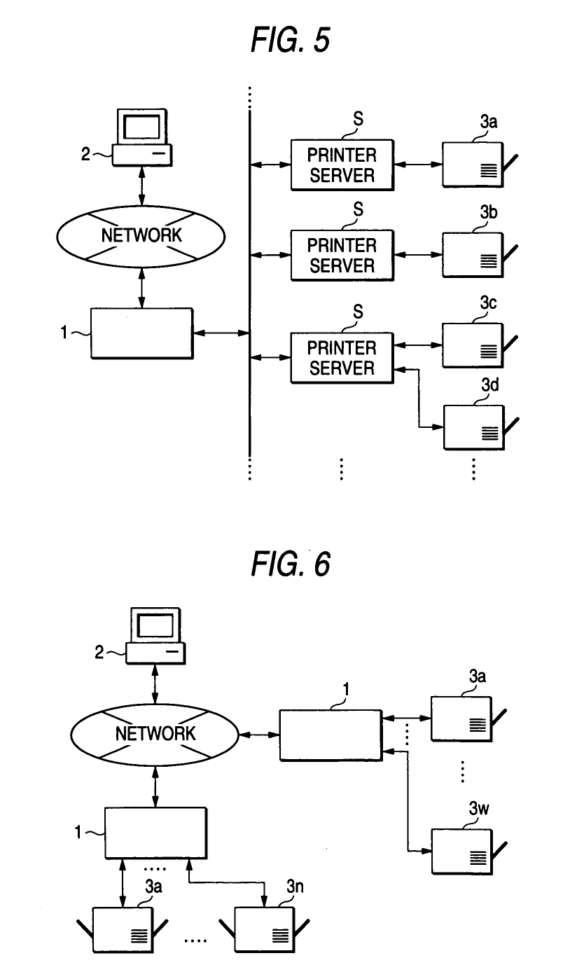

Moreover, the image processing apparatus 1 may generate forming processing images corresponding to one or some of the designated printer devices 3, and another image processing apparatus 1 may generate forming processing images corresponding to the remaining ones of the designated printer devices 3. Next, a second embodiment of the present invention will be described. An image processing apparatus 1 according to this embodiment is connected to another image processing apparatus 1 via a network, as shown in FIG. 6. Each image processing apparatus 1 has a structure similar to the structure described in the first embodiment shown in FIG. 1, but the contents of the processing in the control unit 11 are slightly different.

That is, the control unit 11 in this embodiment, upon receiving input of an image forming instruction received by the communication unit 13 from the user-side device 2, stores the data of the image forming instruction to the storage unit 12. Then, the control unit 11 acquires information specifying printer devices 3 with reference to a printer parameter part, from the data stored in the storage unit 12.

The control unit 11 selects a printer device that has not been selected yet as a target printer device 3 from the information specifying the printer devices 3, and extracts optional settings related to the target printer device 3 from the optional settings of the data stored in the storage unit 12 (the processing up to this point is similar to the processing in the first embodiment shown in FIG. 4).

Next, the control unit 11 in this embodiment judges whether a forming processing image corresponding to the selected target printer device 3 can be generated or not. This judgment can be made, for example, by storing a list of information specifying the printer devices 3 for which a forming processing image can be generated (model name of printer device 3 and the like) to the storage unit 12 in advance.

Here, if a forming processing image corresponding to the selected target printer device 3 can be generated, the control unit 11 generates a forming processing image for the target printer device 3 on the basis of the extracted option information and the image forming instruction stored in the storage unit 12, and stores this forming processing image and the information specifying the target printer device 3 in association with each other to the storage unit 12.

The control unit 11 also checks whether there is any printer device that has not been selected as a target printer device 3, of the designated printer devices 3. If there is a printer device 3 that has not bee selected, the control unit 11 repeats the processing from the processing to select the printer device 3 that has not been selected as a target printer device 3. If there is no printer device 3 that has not been selected, the control unit 11 outputs each of the data of the forming processing images stored in the storage unit 12 to the printer devices 3 specified by the respective associated information items (that is, the control unit 11 outputs the data of each forming processing image to the corresponding printer device 3).

When it is judged that a forming processing image corresponding to the selected target printer device 3 cannot be generated, the control unit 11 searches for an image processing apparatus 1 that can generate a forming processing image corresponding to the target printer device 3. By storing information specifying another image processing apparatus 1 (for example, network addresses) and information associating this other image processing apparatus 1 with the corresponding printer device 3 to the storage unit 12 in advance, this search can be performed on the basis of the information stored in the storage unit 12.

Then, the control unit 11 sends the information specifying the target printer device 3, the extracted option information and the image forming instruction stored in the storage unit 12 to the other image processing apparatus 1 found as a result of the search (hereinafter referred to as “accepting-side image processing apparatus” if discrimination is necessary).

In the accepting-side image processing apparatus 1 having received the information specifying the target printer device 3, the option information and the image forming instruction from the image processing apparatus 1 (hereinafter referred to as “requesting-side image processing apparatus” if discrimination is necessary), the following processing is performed. That is, the control unit 11 generates a forming processing image for the target printer device 3 specified by the received information on the basis of the received option information and image forming instruction, and outputs the forming processing image to the target printer device 3 (that is, the control unit 11 outputs the data of the forming processing image to the corresponding printer device 3).

Also according to this embodiment, even when one document must be printed by plural printer devices, it is not necessary to make a print instruction separately to each printer device and the convenience can be improved.

As described above, according to an aspect of the invention, an image processing apparatus includes: an accepting unit that accepts an image forming instruction; a forming image generating unit that generates plural forming processing images corresponding to respective plural image forming devices on the basis of the accepted image forming instruction; and an output unit that outputs the plural forming processing images to the corresponding image forming devices.

In the image processing apparatus, the forming image generating unit may generate at least one of the plural forming processing images to be generated, as a forming processing image in a mode that is different from the other forming processing images. Thus, for example, an imposed output manuscript and comprehensive layout output prints of the individual images can be printed at a time, and also print processing to print a large-size sheet such as A1 size together with its thumbnail image onto a single A3-size sheet can be carried out.

According to another aspect of the invention, an image processing apparatus includes: an accepting unit that accepts an image forming instruction; a forming image generating unit that generates a forming processing image corresponding to a predetermined target image forming device on the basis of the accepted image forming instruction; a sending unit that sends the image forming instruction to another image processing apparatus that generates a forming processing image corresponding to an image forming device that is different from the target image forming device; and an output unit that outputs the generated forming processing image to the target image forming device.

According to still another aspect of the invention, an image processing apparatus includes: an accepting unit that accepts an image forming instruction; a forming image generating unit that generates plural forming processing images according to plural forming modes that are different from each other on the basis of the accepted image forming instruction; and an output unit that outputs the plural forming processing images to an image forming device.

According to still another aspect of the invention, an image processing method includes: by using a computer, accepting an image forming instruction; generating plural forming processing images corresponding to respective plural image forming devices on the basis of the accepted image forming instruction; and outputting the plural forming processing images to the corresponding image forming devices.

According to still another aspect of the invention, an image processing method includes: by using a computer, accepting an image forming instruction; generating a forming processing image corresponding to a predetermined target image forming device on the basis of the accepted image forming instruction; sending the image forming instruction to another image processing apparatus that generates a forming processing image corresponding to an image forming device that is different from the target image forming device; and outputting the generated forming processing image to the target image forming device.

According to still another aspect of the invention, a storage medium stores a program executable by a computer to perform a function including the steps of: accepting an image forming instruction; generating plural forming processing images corresponding to respective plural image forming devices on the basis of the accepted image forming instruction; and outputting the plural forming processing images to the corresponding image forming devices.

According to still another aspect of the invention, a storage medium stores a program executable by a computer to perform a function including the steps of: accepting an image forming instruction; generating a forming processing image corresponding to a predetermined target image forming device on the basis of the accepted image forming instruction; sending the image forming instruction to another image processing apparatus that generates a forming processing image corresponding to an image forming device that is different from the target image forming device; and outputting the generated forming processing image to the target image forming device.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2004-136745 filed on Apr. 30, 2004 including specification, claims, drawings and abstract is incorporated herein by reference in its entirety.

1. An image processing apparatus comprising:
an accepting unit that accepts an image forming instruction;
a forming image generating unit that generates a plurality of forming processing images corresponding to a respective plurality of image forming deviceson the basis of the accepted image forming instruction; and
an output unit that outputs the plurality of forming processing images to the respective corresponding image forming devices.

2. The image processing apparatus as claimed in claim 1, wherein the forming image generating unit generates at least one of the plurality of forming processing images as a forming processing image in a mode that is different from the other forming processing images.

3. An image processing apparatus comprising:
an accepting unit that accepts an image forming instruction;
a forming image generating unit that generates a forming processing image corresponding to a predetermined target image forming device on the basis of the accepted image forming instruction;
a sending unit that sends the image forming instruction to another image processing apparatus that generates a forming processing image corresponding to an image forming device that is different from the target image forming device; and
an output unit that outputs the generated forming processing image to the target image forming device.

4. An image processing apparatus comprising:
an accepting unit that accepts an image forming instruction;
a forming image generating unit that generates a plurality of forming processing images according to a plurality of forming modes that are different from each other on the basis of the accepted image forming instruction; and
an output unit that outputs the plurality of forming processing images to an image forming device.

5. An image processing method comprising:
accepting an image forming instruction;
generating a plurality of forming processing images corresponding to a respective plurality of image forming deviceson the basis of the accepted image forming instruction; and
outputting the plurality of forming processing images to the respective corresponding image forming devices.

6. An image processing method comprising:
accepting an image forming instruction;
generating a forming processing image corresponding to a predetermined target image forming device on the basis of the accepted image forming instruction;
sending the image forming instruction to another image processing apparatus that generates a forming processing image corresponding to an image forming device that is different from the target image forming device; and
outputting the generated forming processing image to the target image forming device.

7. A storage medium storing a program executable by a computer to perform a function for image processing, comprising the steps of:
accepting an image forming instruction;
generating a plurality of forming processing images corresponding to a respective plurality of image forming devices on the basis of the accepted image forming instruction; and
outputting the plurality of forming processing images to the respective corresponding image forming devices.

8. A storage medium storing a program executable by a computer to perform a function for image processing, comprising the steps of:
accepting an image forming instruction;
generating a forming processing image corresponding to a predetermined target image forming device on the basis of the accepted image forming instruction;
sending the image forming instruction to another image processing apparatus that generates a forming processing image corresponding to an image forming device that is different from the target image forming device; and
outputting the generated forming processing image to the target image forming device.
